(19) United States
(12) Patent Application Publication
(10) Pub. No.: US 2011/0173273 A1
(43) Pub. Date: Jul. 14, 2011

(54) METHOD AND SYSTEM FOR INHIBITING PHISHING

(75) Inventor: Werner Krachtus, Bechtsrieth (DE)

(73) Assignee: MOTIONDRIVE AG, Weiden (DE)

(21) Appl. No.: 12/687,771

(22) Filed: Jan. 14, 2010

(51) Int. Cl. G06F 21/00; G06F 15/16

(52) U.S. Cl. 709/206; 726/26

(57) ABSTRACT

A system according to the invention comprises a communication device 1, an authorized website server 2 having a website 20 and an unauthorized website server 3 having a phishing website 30. Before starting internet transactions a client provides a pool 10 of personal data, e. g. digital image data to the authorized server 2. After submitting these data, whenever the authorized server sends an e-mail message 21 to the communication device 1, some of the personal data 11 of the pool 10 of personal data are attached to the e-mail 21. Thus the client 1 knows that the e-mail originates from the authorized server 2.

### BACKGROUND OF THE INVENTION

1. Technical Field

The application refers to a method and system for inhibiting phishing.

2. Background

Internet transactions such as banking and commerce require secure transmission of personal data and information. In order to carry out transactions securely, a user usually has to submit personal data and/or information to a remote website server. Personal data and information may include passwords, TAN's, PIN's, credit card numbers, account numbers, etc., may be used to identify the user and allow him to effect a transaction. In order to prevent fraud personal data and information should be kept confidential.

Phishing refers to a form of fraud in which an unauthorized website server pretends to be an authorized website server, e.g. by copying the authorized website server's appearance and/or by using a similar domain name. The aim of phishing is to make a client reveal personal data and information. Usually, an electronic message (an e-mail or SMS) is sent to a client pretending that the origin of the e-mail was an authorized internet location known to the client, e.g. an internet location of the client's bank, by imitating the appearance of the website of the authorized website server. Unsuspecting users may then submit private data to an internet location associated with a phishing site, particularly to a phishing site having a domain name which is confusingly similar with the corresponding domain name of the authorized website server. The domain name may be provided as a link to the phishing website.

It is an object of the present invention to provide a method and system for inhibiting phishing activities of unauthorized users.

### SUMMARY OF THE INVENTION

A method for inhibiting phishing according to the invention comprises the steps: a) submitting one or a plurality of sets of personal data to an authorized website server by a client; b) storing of said personal data at an internet location associated with said authorized website server; and c) attributing at least one of said sets of personal data to a message sent from the authorized website server to a client for indicating the authentic origin of the message from the authorized website server.

The process step c) includes linking a set of personal data selected from a pool of sets of personal data submitted by the client beforehand to a message, sending/transmitting the message including the selected set(s) of personal data and displaying the set(s) of personal data upon opening of the message by the client. I.e. as soon as the client opens e.g. an e-mail, a personal photograph, a personal slogan, or a personal identification code is automatically displayed. It may be displayed as an image and/or sound (e.g. a slogan). In an alternative embodiment the client may click a button in the message for starting displaying the personal data attached to the message. Each set of data represents e.g. an image, a song, a melody or a text personally selected and submitted by the user.

Due to the fact that the personal data had been submitted (uploaded) by the client to the authorized web server beforehand, only he knows whether the displayed data indicate that the message is from the authorized server and that the links associated with the message are trustable. As long as there is no indication of personal data, the client will not click an internet link associated with the message and reveal personal data and information. In this way the system may prevent clients from submitting personal data to an unauthorized web location. Thus phishing can be considerably inhibited.

Said process step c) may furthermore include attaching at least one of said sets of personal data to a message to be sent from the authorized website server to the client.

Said process step c) may include displaying said set(s) of personal data upon a demand made by the client. Said process step c) may include providing in the message a link to at least one of said personal data. By clicking the link (e.g. an URL) a set of personal data is displayed.

Said personal data submitted by the client includes at least one of image data, sound data, and text data. Said personal data may include a plurality of data, e.g. various digital photographs. Thus the website server may select one or more of the data and include them in a message sent to the client.

Said process step c) may include attributing at least one of said plurality of data sets to one of a plurality of messages, and at least another one of said plurality of data sets to another one of said plurality of messages. The server may associate the data with the messages in a particular order when sending various messages subsequently.

In a preferred embodiment of the invention said process step c) includes attributing at least a first one of said plurality of data sets to a first message, and at least a second one of said plurality of data sets to a second message.

It is preferred that said first one of said plurality of data sets is different from said second one of said plurality of data sets. The server may associate data selected in a particular manner known to the client. Furthermore, the server may associate data alternately or the server may use particular data only in one message and then delete them so that they may not be used in subsequent messages. The latter may increase the security standard.

Each of said plurality of data sets is attributed to a particular message.

A system for inhibiting phishing according to the invention comprises: a website server; and at least a client configured for exchanging data with said website server via a network; wherein said website server is associated with an internet location for storing one or a plurality of sets of personal data submitted by said client to said website server; and wherein said website server is configured for attributing at least one of said plurality of sets of personal data to one of a plurality of messages every time a message is sent to the client.

The website server comprises an anti-phishing functionality or a phishing warning system which indicates to a client that a message is from an authentic server.

The client may receive a message, e.g. an e-mail or SMS message, on a mobile network device, a personal computer, etc. The network connecting the client and the website server may comprise a wire network and/or wireless network components.

Said personal data may include at least one of image data, sound data, and text data. The image attached to the message may also be a combination of image data and text/sound data, e.g. an image showing a combination of a picture and text/sound, a sequence of pictures, text converted into a picture, etc.

Another possibility (or an additional feature of the invention) would be to show a set of personal data out of the pool of personal data submitted by the user to the website server when the landing page is displayed in the communication device of the user. After the user has entered his login and is recognized by the authorized server, a set of personal data is displayed in a pop-up before the user enters a password or other confidential data. Of course, when the user accesses a phishing landing page, there is no personal data set shown because personal data have never been submitted by the user to the unauthorized website server.

Said website server is configured for attributing at least one of said plurality of sets of personal data to one of a plurality of messages, and at least another one of said plurality of sets of personal data to another one of said plurality of messages. It is preferred that said first one of said plurality of sets of personal data is different from said second one of said plurality of sets of personal data.

A website server which is configured for exchanging data with a client via a network, wherein said website server is associated with an internet location configured for storing one or a plurality of sets of personal data submitted by said client to said website server; and wherein said website server is configured for attributing at least one of said plurality of sets of data to one of a plurality of messages every time a message is sent to the client.

### BRIEF DESCRIPTION OF THE DRAWINGS

For a better understanding of the invention reference will now be made to the accompanying drawings.

FIG. 1 illustrates a schematic view of a system according to the invention; and

FIG. 2 illustrates a flow chart showing a method according to the invention.

### DETAILED DESCRIPTION

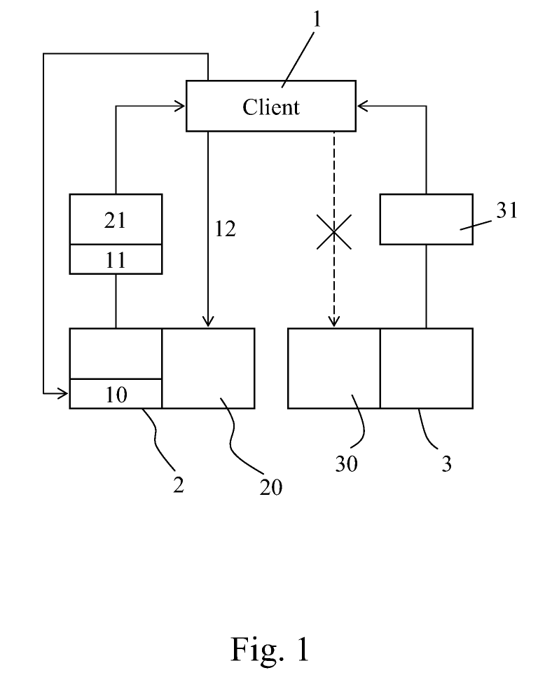

Reference is made to FIG. 1 showing a schematic view of a system according to the invention.

A client or user communicates with internet locations (like other users or website servers) via the internet by means of a communication device 1. The communication device 1 may be a mobile (wireless) device, a computer, a. s. o.

A website server 2 (service provider) has a website 20 for accomplishing internet transactions such as banking and commerce. In order to carry out transactions securely, a user has to submit personal data such as passwords, TAN's, PIN's, credit card numbers, account numbers, etc. This is no problem when the user enters an authorized website 20 belonging to an authorized service provider 2.

However, there is a risk that a user enters personal data in a (phishing) website 30 of an unauthorized website server 3. A common way to make a user access a phishing website 30 is to send an e-mail 31 containing a link to the phishing website 30 (URL) pretending that the origin of the e-mail was an authorized internet location known to the user. A trustful user may not check the URL before entering personal data.

According to the invention a client provides a pool 10 of personal data, e.g. digital image data, particular sound data, text data, etc. to the authorized server 2 at the time of starting using the services of the authorized server 2. After submitting these data, whenever the authorized server sends an e-mail message 21 to the client 1, some of the personal data 11 of the pool 10 of personal data are attached to the e-mail 21. When the client 1 receives the e-mail 21 the attached personal data 11 are displayed or may be opened by the client 1. Consequently, the client 1 knows that the e-mail originates from the authorized server 2. Only if he recognizes his personal data 11 the client 1 will open a website 20 linked to the e-mail 21 and submit confidential data 12 in the website 20 in order to start an internet transaction. If there are no personal data 11 linked to an e-mail 31 he will not open a website 30 linked to an e-mail 31. Missing personal data indicate that the origin of the e-mail may not be authentic.

Thus phishing may be prevented or inhibited by enabling the user to distinguish between an authentic e-mail having a link to an authentic website and a phishing e-mail having a link to a phishing website.

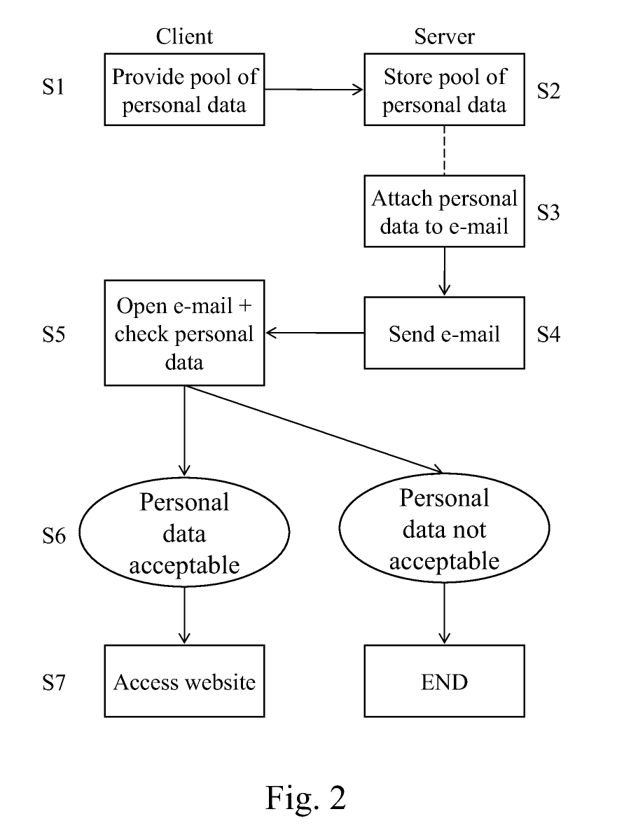

FIG. 2 illustrates a flow chart of method steps according to the invention.

In a first step S1 a client/user provides a pool of personal data to a website server, e.g. image data of personal photographs, text data selected by the user, or sound data of e.g. selected music. The pool may comprise one or a plurality of data sets.

In step S2 the server receives and stores the pool of data and attributes them to the sender. The server may confirm receipt of the data and, in a particular embodiment of the invention, indicate which data would be attached to e-mail correspondence sent from the server to the client and/or the temporal order. For example, the server may indicate that first image data would be attached to a first e-mail, second image data to a second e-mail, etc.

When sending a first e-mail in step S3 the server will attach first data out of the pool of personal data to the first e-mail and then send the e-mail to the user (S4).

In step S5 the user opens the e-mail. Before opening a website by clicking a link shown in the e-mail the user checks the authenticity of the sender of the e-mail. If personal data are displayed or may be displayed by clicking a link or by opening a file the user can be sure that the sender is authentic and the content of the e-mail is reliable (S6). If the client finds out that his personal data are displayed and correct, he may access a website indicated in the e-mail. If there are no personal data indicated or if the personal data do not correspond to data submitted in the pool of personal data the client may doubt whether the sender of the e-mail is authentic or whether an attempt of phishing has been made. The client may delete the e-mail. At least he may be aware that there is a high risk when submitting confidential data to a website referred to in this e-mail. Consequently the risk of submitting confidential data to an unauthorized sender unintentionally is reduced.

I claim:

1. A method for inhibiting phishing, comprising the steps:
a) transmitting one or a plurality of sets of personal data to an authorized website server;
b) storing of said personal data at an internet location associated with said authorized website server; and
c) attributing at least one of said sets of personal data to a message sent from the authorized website server to a client for indicating the authentic origin of the message from the authorized website server.

2. The method of claim 1, wherein
said process step c) includes displaying said set of personal data attributed to the message when a client opens the message.

3. The method of claim 1, wherein
said process step c) includes attaching at least one set of said personal data sets to a message sent from the authorized website server to the client.

4. The method of claim 1, wherein
said process step c) includes displaying said set of personal data upon a request by the client.

5. The method of claim 1, wherein
said personal data includes at least one of image data, sound data, and text data.

6. The method of claim 1, wherein
said personal data includes a plurality of data sets.

7. The method of claim 6, wherein
said process step c) includes attributing at least one of said plurality of data sets to one of a plurality of messages, and at least another one of said plurality of data sets to another one of said plurality of messages.

8. The method of claim 6, wherein
said process step c) includes attributing at least a first one of said plurality of data sets to a first message, and at least a second one of said plurality of data sets to a second message.

9. The method of claim 8, wherein
said first one of said plurality of data sets is different from said second one of said plurality of data sets.

10. The method of claim 1, wherein
each of said plurality of data sets is attributed to a particular message.

11. A system for inhibiting phishing, comprising:
a website server; and
at least a client configured for exchanging data with said website server via a network;
wherein said website server is associated with an internet location for storing one or a plurality of sets of personal data submitted by said client to said website server; and
wherein said website server is configured for attributing at least one of said plurality of sets of data to one of a plurality of messages every time a message is sent to the client.

12. The system of claim 11, wherein
said website server comprises an anti-phishing functionality.

13. The system of claim 11, wherein
said sets of personal data include at least one of image data, sound data, and text data.

14. The system of claim 11, wherein
said website server is configured for attributing at least one of said plurality of sets of personal data to one of a plurality of messages, and at least another one of said plurality of sets of data to another one of said plurality of messages.

15. The system of claim 14, wherein
said first one of said plurality of sets of data is different from said second one of said plurality of sets of data.

16. A website server which is configured for exchanging data with a client via a network;
wherein said website server is configured for storing one or a plurality of sets of personal data submitted by said client to said website server; and
wherein said website server is configured for attributing at least one of said plurality of sets of data to one of a plurality of messages every time a message is sent to the client.
